(19) United States
(12) Patent Application Publication
(10) Pub. No.: US 2005/0085230 A1
(43) Pub. Date: Apr. 21, 2005

(54) Circuit and method for producing a pilot strength measurement message

(75) Inventors: William E. Welnick, Poway, CA (US); William P. Alberth JR., Crystal Lake, IL (US); Brian D. Storm, Round Lake Beach, IL (US)

Correspondence Address: VEDDER PRICE KAUFMAN & KAMMHOLZ, 222 N. LASALLE STREET, CHICAGO, IL, 60601, US

(73) Assignee: Motorola, Inc., Schaumburg, IL (US)

(21) Appl. No.: 10/687,418

(22) Filed: Oct. 16, 2003

(51) Int. Cl. H04Q 7/20

(52) U.S. Cl. 455/437; 455/226.2; 455/67.11; 370/332

(57) ABSTRACT

A circuit (2) and method acquires a pilot signal and produces a pilot strength measurement message (PSMM) (4). The circuit (2) includes a pilot strength measurement message generator (20). The pilot strength measurement message generator (20) receives the long term filtered measurement data (22) corresponding to at least one pilot signal (70) to produce the pilot strength measurement message (4). The pilot strength measurement message generator (20) produces the pilot strength measurement message (4) based on at least the long term filtered measurement data (22). According to one embodiment, a wireless device (10) employs a first receiver (30) to generate the long term filtered measurement data (22), a second receiver (40) to generate short term filtered measurement data (24), and the pilot strength measurement message generator (20) for producing the pilot strength measurement message (4).

### FIELD OF THE INVENTION

The invention relates generally to wireless communication systems, and more particularly to producing pilot strength measurement messages (pilot strength measurement message).

### BACKGROUND OF THE INVENTION

A wireless communication system includes a number of base stations, scattered over a geographic area, to provide service for a number of wireless devices, such as, personal data assistants (PDA), cellular phones, pagers, smart phones, and other suitable devices that can move throughout a geographic area. According to the Interim Standard IS-95-A, which has been adopted by the Telecommunications Industry Association for implementing code division multiple access (CDMA), each base station continuously transmits a pilot channel signal on the forward channel. The pilot channel signal transmitted by each base station has the same spreading code but with a different code phase offset. The phase offset allows the pilot signals to be distinguished from one another, which in turn allows the base stations to be distinguished. The wireless device monitors the pilots and measures the received energy of the pilots.

While the wireless device is communicating with the base station(s), the wireless device must constantly monitor and maintain three sets of pilot signals (collectively referred to as a Pilot Set)—an active set, a candidate set, and a neighbor set. The active set consists of pilot signals associated with the forward traffic channels assigned to service the wireless device. The candidate set consists of pilots that are not currently in the active set but have been received by a particular wireless device with sufficient signal strength to indicate that the associated forward traffic channels could be successfully demodulated. This is otherwise known as acquiring a pilot. The neighbor set consists of pilot signals that are not currently in the active set or candidate set but are likely candidates for hand off.

As the wireless device moves from the region covered by one base station to another, the wireless device promotes certain pilots from the neighbor set to the candidate set, and certain pilots of the candidate set are subsequently promoted to the active set by the base station. The wireless device provides the base station or base stations pilot signal strength measurement data corresponding to the received energy of the pilot signals via a pilot strength measurement message (pilot strength measurement message). In response, the base station notifies the wireless device of the promotion from the candidate set to the active set via a hand off direction message. The process of continually updating the pilot set during a call is referred to as “pilot set maintenance.”

In a rapidly changing propagation environment, such as when the wireless device goes around the corner of a large building, the active pilots may be rapidly shadowed, and the measured energy of a neighbor pilot may suddenly change from very weak to very strong or vice versa. If the wireless device is not able to accurately measure the pilot energy, the wireless device may improperly promote the new neighbor to the candidate set.

A scan search receiver sweeps the pilot signal of the active pilots and of the candidate pilots to determine the pilot channel strength of each pilot. The scan search receiver determines pilot channel strength by a complex correlation process which provides a short term average measure of E_{C}/I_{O} in decibels (dB), where E_{C} is a measure of the pilot energy and I_{O} is the total power spectral density in the received bandwidth. This power measurement will be referred to as the short term average E_{C}/I_{O} and represents a signal-to-signal+noise ratio.

A pilot signal emanating from a base station may travel along several paths called “rays,” thus producing multi-path signals. In performing a sweep of the pilot signal the scan search receiver sets a multiple chip window centered on the code phase off-set of the particular pilot signal. The purpose of the sweep of the chip window is to develop a multi-path profile of the pilot channel. The scan search receiver produces a complex correlation and measure of the short term average E_{C}/I_{O} for each of the multiple chip off-sets of the chip window in searching for the strongest ray of the pilot that appears in the chip window.

The multi-path pilot signals are provided to a rake receiver comprised of a plurality of finger receivers connected in parallel. The scan search receiver provides short term filtered measurement data corresponding to the short term average E_{C}/I_{O} for the strongest ray to a pilot strength measurement message generator and is used in determining whether a finger receiver should be assigned to the strongest ray of the swept pilot signal E_{C}/I_{O}. The chip off-set presenting the strongest ray is used by the assigned finger receiver to track the corresponding pilot signal. The finger receiver continually tracks the strongest ray, and thus produces long term filtered measurement data corresponding to the strongest ray. The plurality of finger receivers may track multiple pilot signals as the scan search receiver continues to sweep the neighbor pilots of the neighbor set. The operation of the finger receivers and search receiver is controlled in part by the pilot strength measurement message generator.

Depending on the number of fingers provided in the wireless device, multiple fingers can be assigned to multiple rays of the same active pilot to obtain a pilot signal strength representative of the combined rays. While the finger receiver is tracking the pilot signal, it is possible that the signal strength will diminish to an unacceptable level indicating that the pilot channel has been lost. When this happens, the finger receiver can be unlocked and made available for assignment to other pilot channels.

According to one method, when the scan search receiver measures the energy of a pilot to be above a certain threshold, the pilot is promoted to the candidate set. Conversely, when the candidate pilot is scanned and its measured energy is below the threshold, its state is demoted. However, the scan search receiver's short term average energy measurement of a pilot signal is not very reliable in the presence of Rayleigh Fading (the rapid variations of path loss as is known in the art), and some neighbor pilot signals may be promoted when the energy of the neighbor pilot signal is not above the threshold. Consequently, some neighbor pilot signals may be improperly promoted to the candidate set and assigned to the active set by the network. As a result, the assign pilot signals may be too weak to function as an active pilot and therefore, may result in a dropped call.

### BRIEF DESCRIPTION OF THE DRAWINGS

The present invention is illustrated by way of example and not limitation in the accompanying figures, in which like reference numerals indicate similar elements, and in which:

FIG. 1 is a block diagram illustrating one example of a circuit for producing a pilot strength measurement message according to one embodiment of the invention;

FIG. 2 is a flow chart illustrating one example of a method for producing a pilot strength measurement message according to one embodiment of the invention;

FIG. 3 is a block diagram illustrating an example of a wireless device for producing a pilot strength measurement message according to one exemplary embodiment of the invention;

FIG. 4 is a flow chart illustrating another example of a method for producing a pilot strength measurement message according to another embodiment of the invention; and

FIG. 5 is a block diagram illustrating another example of a wireless device for producing a pilot strength measurement message according to another exemplary embodiment of the invention.

### DETAILED DESCRIPTION OF THE PREFERRED EMBODIMENTS

A circuit and method acquires a pilot signal and produces a pilot strength measurement message (PSMM) corresponding to the pilot signal. The circuit includes a pilot strength measurement message generator to receive long term filtered measurement data corresponding to at least one pilot signal. The pilot strength measurement message generator produces the pilot strength measurement message based on at least the long term filtered measurement data.

According to one embodiment, a wireless device employs a first receiver, a second receiver, and the pilot strength measurement message generator for producing the pilot strength measurement message. The first receiver receives the at least one pilot signal and in response, generates long term filtered measurement data corresponding to the at least one pilot signal. For example, the first receiver may be a finger receiver for producing the long term filtered measurement data as previously described. According to one embodiment, the pilot strength measurement message generator also receives short term filtered measurement data corresponding to the at least one pilot signal to produce the pilot strength measurement message. The second receiver also receives the at least one pilot signal and in response, generates short term filtered measurement data corresponding to the at least one pilot signal. For example, the second receiver may be a scan search receiver for producing short term filtered measurement data as previously described. The pilot strength measurement message generator is coupled to the first receiver and to the second receiver.

As previously described, the function of the scan search receiver is to perform a sweep of the pilot signals in order to develop a multi-path profile for the pilot channel. The signal strength measurement of each pilot signal is based on a short term average E_{C}/I_{O}. The scan receiver provides the short term average E_{C}/I_{O} for the strongest ray to the pilot strength measurement message generator in order to determine if a finger receiver should be assigned to the strongest ray. When locked on to a pilot signal, the finger receiver can provide an accurate long term filtered measure of the pilot signal strength. The finger receiver provides a long term filtered measure of E_{C}/I_{O} but, unlike the short term average E_{C}/I_{O} provided by the scan search receiver, the finger receiver provides an E_{C}/I_{O} measurement that has been filtered over a relatively long period of time and represents a cumulative measure of E_{C}/I_{O}. In simple terms, the short term average E_{C}/I_{O} can be considered a snap shot of the pilot strength whereas the long term average E_{C}/I_{O} is a long term look at the pilot's strength. Because of such factors as Rayleigh Fading which causes the energy of the pilot signal to rapidly change, the short term average E_{C}/I_{O} is not as accurate as the long term average E_{C}/I_{O}.

Among other advantages, the present invention improves the accuracy for producing the pilot strength measurement message. According to one embodiment of the invention, when locked onto a pilot channel, the finger receiver can provide an accurate measure of the pilot signal strength. As previously stated, because of such factors such as Raleigh fading which causes the energy of the pilot signal to rapidly change, the short term average E_{C}/I_{O} may not provide an accurate measurement of the pilot signal strength. Since the finger receivers provide a long term average of the pilot signal strength, rapid changes in the pilot signal strength caused by, for example, Raleigh fading, will affect the accuracy of the signal strength measurement to a lesser degree when compared to the short term average signal strength measurement data produced by the scan search receiver. For example, a short term peak fluctuation of the pilot signal may cause a short term filtered measurement to appear higher than the long term filtered signal strength of the pilot signal. As a result, the short term filtered measurement of a marginally weak pilot signal will appear stronger than it actually is thus keeping the pilot signal active longer. Similarly, the use of the short term filtered measurement data for relatively strong pilot signals will result in keeping the marginally weak pilot active longer than if the long term filtered signal strength measurement is used for the same pilot signal. Consequently, the use of the finger receiver to produce long term filtered signal strength measurements may provide a more accurate indication of the pilot signal strengths than the short term filtered measurement data from the scan search receiver. As a result of improving the accuracy of the pilot strength measurement message, pilots will be more accurately promoted and demoted within the pilot set. Consequently, the likelihood of keeping a marginally weak pilot signal active is reduced, and therefore, the likelihood of a marginally weak active pilot signal resulting in a dropped call is also reduced.

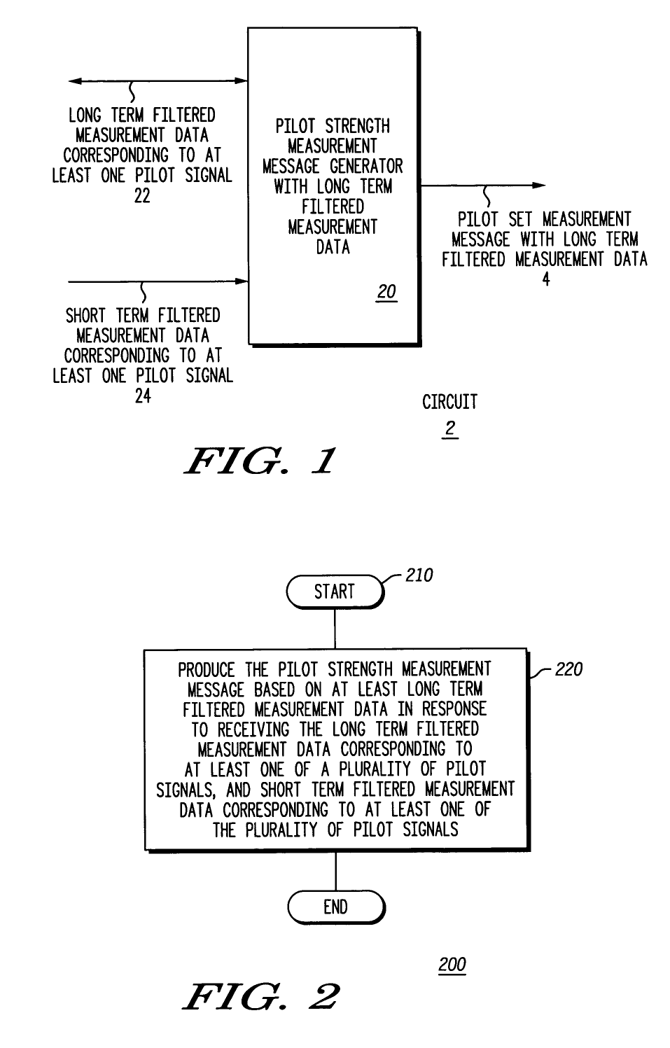

FIG. 1 is a block diagram illustrating one exemplary embodiment of a circuit 2 to produce a pilot strength measurement message (PSMM) 4. The circuit 2 includes a pilot strength measurement message generator 20 to receive long term filtered measurement data 22 corresponding to at least one pilot signal. The pilot strength measurement message generator 20 produces the pilot strength measurement message 4 based on at least the long term filtered measurement data 22. According to one embodiment, the pilot strength measurement message generator 20 receives short term filtered measurement data 24 corresponding to the at least one pilot signal to produce the pilot strength measurement message 4.

The pilot strength measurement message generator 20 may be one or more suitably programmed processors such as a microprocessor, a microcontroller, or a digital signal processor and therefore includes associated memory that contains executable instructions that when executed causes the pilot strength measurement message generator 20 to carry out the operations described herein. Alternatively, as used herein, the pilot strength measurement message generator 20 includes discrete logic, state machines or any other suitable combination of hardware, software and or firmware. The pilot strength measurement message generator 20 produces the pilot strength measurement message 4 based on the long term filtered measurement data 22, the short term filtered measurement data 24 or any combination thereof The memory may be, for example, random access memory (RAM), read only memory (ROM), optical memory, or any suitable storage medium located locally or remotely such as via a server. Additionally, the memory may be accessible by a base station, switching system, or any suitable network element via the Internet, a wide access network (WAN), a local area network (LAN), a wireless wide access network (WWAN), a wireless local area network (WLAN), an IEEE 802.11 wireless network, a bluetooth network or any suitable communication interface or network.

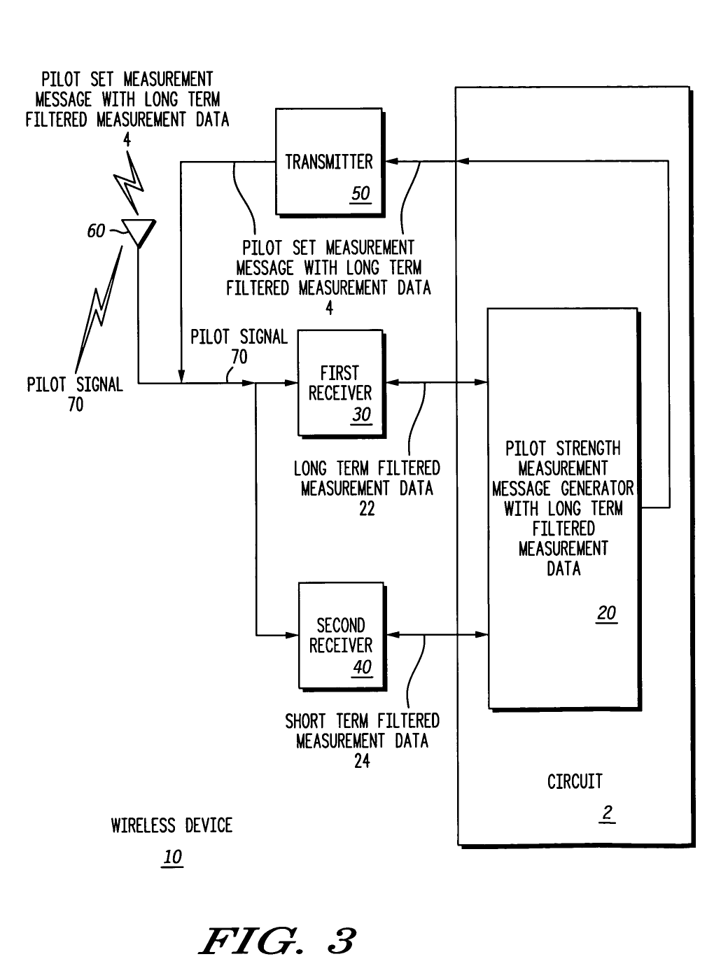

FIG. 2 illustrates a method 200 for producing a pilot strength measurement message 4 according to one embodiment of the invention. The method 200 may be carried out by the pilot strength measurement message generator 20 in circuit 2. However, any other suitable structure may be used. It will be recognized that method 200, beginning with step 210 will be described as a series of operations, however, the operations may be performed in any suitable order and may be repeated in any suitable combination.

As shown in step 220, the pilot strength measurement message generator 20 produces the pilot strength measurement message 4 based on at least the long term filtered measurement data 22. The pilot strength measurement message generator 20 produces the pilot strength measurement message 4 in response to receiving the long term filtered measurement data 22 corresponding to at least one of a plurality of pilot signals. According to one embodiment, the long term filtered measurement data 22 includes the short term filtered measurement data 24corresponding to at least one of a plurality of pilot signals.

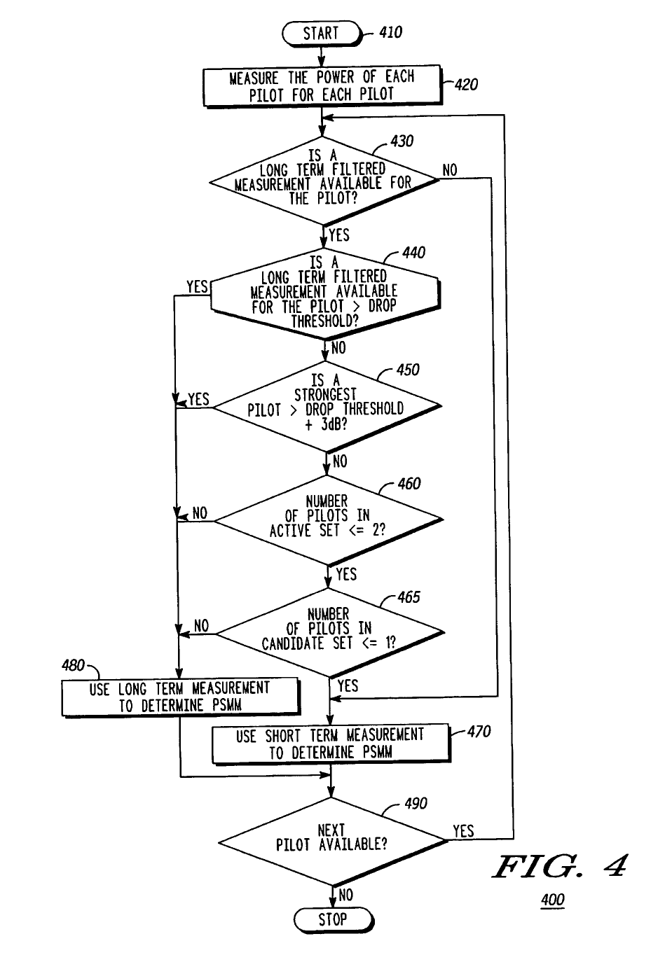

FIG. 3 is a block diagram illustrating one exemplary embodiment of a wireless device 10 including the pilot signal strength measurement generator 20. Wireless device 10 includes the pilot strength measurement message generator 20, a first receiver 30, a second receiver 40, and a transmitter 50, coupled to an antenna 60. As used herein, wireless device 10 may be any device capable of transmitting the pilot strength measurement message 4 and may include, for example, a cell phone, a personal digital assistant (PDA), a two-way radio, a wireless fidelity device (WiFi, i.e., a device based on the IEEE 802.11 specification), a blue tooth compliant device, or any suitable communication device. The first receiver 30 (such as one or more finger receivers) receives at least one pilot signal 70. In response to receiving the pilot signal 70, first receiver 30 generates long term filtered measurement data 22. The second receiver 40, such as a scan search receiver, also receives the at least one pilot signal 70. In response to receiving the at least one pilot signal 70, the second receiver 40 generates short term filtered measurement data 24. The pilot strength measurement message generator 20 is coupled to the first receiver 30 and to the second receiver 40 in order to receive the long term filtered measurement data 22 generated by the first receiver 30 and the short term filtered measurement data 24 generated by the second receiver 40. The various elements of the wireless device 10 are linked together by a plurality of links. The links may be any suitable mechanisms for conveying electrical signals or data as appropriate.

FIG. 4 illustrates a method 400 for producing a pilot strength measurement message by the circuit 2 described with respect to FIG. I according to one embodiment of the invention. The method 400 may be carried out by the circuit 2. However, any other suitable structure may be used. It will be recognized that method 400, beginning with step 410 will be described as a series of operations, however, the operations may be performed in any suitable order and may be repeated in any suitable combination.

As shown in step 420, second receiver 40 measures the power of each pilot signal 70 such as each active, candidate, neighbor or any suitable pilot signal. The following steps may therefore be performed in a loop for each pilot signal measured.

As shown in step 430, if the first receiver 30 is available and is locked to the pilot signal 70, then the first receiver 30 produces the long term filtered measurement data 22. If the long term filtered measurement data 22 is not available, then the pilot strength measurement message generator 20 receives the short term filtered measurement data 24 to produce the pilot strength measurement message 4 as shown in step 470.

As shown in step 440, if the available long term measurement data 22 is greater then a drop threshold, then the long term measurement data 22 is used to produce the pilot strength measurement message 4 as shown in step 480. As previously stated, the long term measurement data 22 may correspond to one of the pilot signals 70 previously measured in step 420. The pilot strength measurement message generator 20 selects the first receiver 30 to receive the long term filtered measurement data 22 in order to produce a more accurate pilot strength measurement message 4.

As shown in step 450, the operation considers the strongest pilot of all pilot signals 70 measured. For example, the pilot strength measurement message generator 20 may select the strongest pilot signal 70 based on measuring the signal strength of each pilot and determining the strongest long term filtered measurement data 22 corresponding to the strongest pilot signal 70. If the strongest pilot measured has energy greater than a drop threshold plus 3dB, then operation continues to step 480 where the long term measurement data 22 is used to produce the pilot strength measurement message 4. For example, the drop threshold may be a threshold signal level for determining that a pilot signal 70 is about to drop. The drop threshold +3 dB is an exemplary value and therefore, this value could be +1 dB, +6 dB, or any other value as determined those skilled in the art.

As shown in step 460, the strongest pilot is less then the drop threshold plus 3dB, the long term measurement data 22 is available and is less than a drop threshold. If there are more than two pilots in the active set then operation continues to step 480 where the long term measurement data 22 is used to produce the pilot strength measurement message 4. If there are two or less active pilots, operation continues to step 465 wherein the number of pilots in the candidate set are examined.

As shown in step 465, if there is more then one candidate pilot, then the pilot strength measurement message generator 20 uses the short term measurement data 24 to produce the pilot strength measurement message 4. If there are no pilots or only one in the candidate set, then the long term measurement data 22 is used to produce the pilot strength measurement message 4.

As shown in step 490, the process ends after each of the pilot signals 70 has been processed. According to one embodiment, a new set of measurements is made for each pilot and the steps above are repeated for each pilot signal 70.

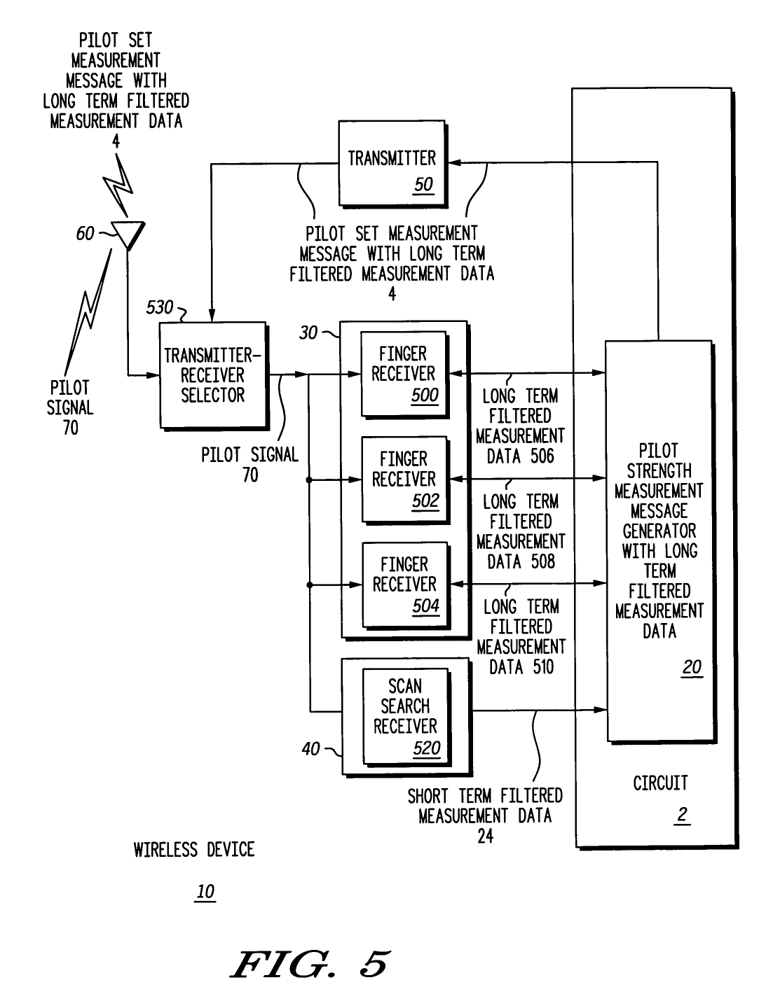

FIG. 5 is a block diagram illustrating another example of wireless device 10 for producing the pilot strength measurement message 4 as shown in FIG. 1. According to this embodiment, first receiver 30 includes a plurality of finger receivers 500, 502, 504, to generate long term filtered measurement data 506, 508, 510 in response to receiving the at least one pilot signal 70. Although first receiver 30 is shown as having three finger receivers 500, 502, 504, first receiver 30 may have any suitable number of finger receivers, such as five, ten, fifteen, or more. Further, according to this embodiment, the second receiver 40 shown in FIG. 1 includes a scan search receiver 520 in FIG. 3. Scan search receiver 520 receives the at least pilot signal 70 and in response, scan search receiver 520 generates the short term filtered measurement data 24. Pilot strength measurement message generator 20 is coupled to the plurality of finger receivers 500, 502, 504 to receive the long term measurement data 506, 508, 510 generated by each of the plurality of finger receivers 500, 502, 504. Further, pilot strength measurement message generator 20 receives the short term filtered measurement data 24 generated by the scan search receiver 520.

As previously described, pilot strength measurement message generator 20 assigns a finger receiver 500, 502, 504 to a pilot signal 70 to lock on and track the pilot signal 70. Pilot strength measurement message generator 20 determines which pilot signal 70, if more than one pilot is present, has the greatest signal strength. For example, if pilot strength measurement message generator 20 requests, at step 420 of FIG. 4, a finger receiver 500, 502, 504, then pilot strength measurement message generator 20 assigns a finger receiver 500, 502. 504, if available, to the appropriate pilot signal 70. Depending on the number of finger receivers available in wireless device 10, multiple finger receivers 500, 502, 504 can be assigned to multiple rays of the same pilot to obtain a pilot signal strength representative of the combined rays. If pilot strength measurement message generator 20 requests a finger receiver 500, 502, 504, for example, as shown in step 432 of FIG. 3, and a finger receiver 500, 502, 504 is not available, then pilot strength measurement message generator 20 selects the short term filtered measurement data 24 corresponding to the appropriate pilot signal 70 produced by scan search receiver 520 as shown in step 470.

Once pilot strength measurement message generator 20 has selected from amongst the available measurement data, such as from the long term filtered measurement data 506, 508, 510 and the short term filtered measurement data 24, the pilot strength measurement message generator 20, then produces the pilot strength measurement message 4. Accordingly, once the pilot strength measurement message generator 20 produces the pilot strength measurement message 4, pilot strength measurement message generator 20 provides the pilot strength measurement message 4 to transmitter 50 to transmit the pilot strength measurement message 4. Transmitter 50 may provide the pilot strength measurement message 4 as a transmitted signal to transmitter receiver selector 530. For example, transmitter receiver selector 530 may be a duplexer, or a switch as is known in the art for allowing transmitter 50 and the first receiver 30 and second receiver 40 to share a common antenna 60. Accordingly, transmitter receiver selector 530 allows transmitter 50 to transmit the pilot strength measurement message 4 onto antenna 60 and transmitter receiver selector 530 allows the first receiver 30 and second receiver 40 to receive pilot signal 70.

Among other advantages, the present invention improves the accuracy of the pilot energy measurements for producing the pilot strength measurement message 4. According to one embodiment of the invention, when locked onto a pilot channel 70, the finger receivers 500, 502, 504 can provide an accurate measure of the pilot signal strength. As previously stated, because of such factors such as Raleigh fading which causes the energy of the pilot signal to rapidly change, the short term average E_{C}/I_{O} may not provide an accurate measurement of the pilot signal strength. Since the finger receivers 500, 502, 504 provide a long term average of the pilot signal strength, rapid changes in the pilot signal strength caused by, for example, Raleigh fading, will affect the accuracy of the signal strength measurement to a lesser degree when compared to the short term filtered measurement data 24 produced by the scan search receiver 520. For example, a short term peak fluctuation of the pilot signal may cause a short term filtered measurement to appear higher than the long term filtered measurement of the pilot signal. As a result, the short term filtered measurement of a marginally weak pilot signal will appear stronger than it actually is thus keeping the pilot channel active longer. Similarly, the use of the short term filtered measurement data 24 for relatively strong pilot signals will result in keeping the marginally weak pilot active longer than if the short term filtered measurement data 24 is used for the same pilot signal. Consequently, the use of the finger receiver 500, 502, 504 to produce long term filtered signal measurement data 506, 508, 510 may provide a more accurate indication of the pilot signal strengths than the short term filtered measurement data 24 from the scan search receiver 520. As a result of improving the accuracy of the pilot strength measurement message, pilots will be more accurately promoted and demoted within the pilot set. Consequently, the likelihood of keeping a marginally weak pilot signal active is reduced, and therefore, the likelihood of a marginally weak active pilot signal resulting in a dropped call is also reduced.

It should be understood that the implementation of other variations and modifications of the invention and its various aspects will be apparent to those of ordinary skill in the art and that the invention is not limited by the specific embodiments described. It is therefore, contemplated to cover by the present invention, any and all modifications, variations or equivalents that fall within the spirit and scope of the basic underlying principles disclosed and claimed herein.

1. A circuit for producing a pilot strength measurement message comprising:
a pilot strength measurement message generator operative to receive long term filtered measurement data corresponding to at least one pilot signal, and in response, operative to produce the pilot strength measurement message including at least the received long term filtered measurement data.

2. The circuit of claim 1 wherein the pilot strength measurement message generator is also operative to receive short term filtered measurement data corresponding to the at least one pilot signal, and wherein the pilot strength measurement message further includes at least the short term filtered measurement data if a strongest pilot signal represented by corresponding long term filtered measurement data is less than a threshold.

3. The circuit of claim 1 wherein the pilot strength measurement message generator is also operative to receive short term filtered measurement data corresponding to the at least one pilot signal, and wherein the at least one pilot signal includes at least one of an active set of pilot signals and a candidate set of pilot signals such that the pilot strength measurement message further includes at least the short term filtered measurement data based on at least one of a number of pilot signals in the active set, and a number of pilot signals in the candidate set.

4. The circuit of claim 1 wherein the pilot strength measurement message generator is also operative to receive short term filtered measurement data corresponding to the at least one pilot signal, and wherein the pilot strength measurement message includes at least the long term filtered measurement data if a strongest pilot signal represented by corresponding long term filtered measurement data is greater than a threshold.

5. The circuit of claim 4 wherein the threshold includes a drop threshold plus 3 dB.

6. A wireless device for producing a pilot strength measurement message comprising:
a first receiver operative to receive at least one pilot signal, and in response, operative to generate long term filtered measurement data corresponding to the at least one pilot signal;
a second receiver operative to also receive the at least one pilot signal, and in response operative to generate short term filtered measurement data corresponding to the at least one pilot signal; and
a pilot strength measurement message generator, operatively coupled to the first receiver and to the second receiver, and operative to produce the pilot strength measurement message including at least the long term filtered measurement data received from the first receiver.

7. The wireless device of claim 6 wherein the pilot strength measurement message further includes at least the short term filtered measurement data if a strongest pilot signal represented by corresponding long term filtered measurement data is less than a threshold.

8. The wireless device of claim 6 wherein the at least one pilot signal includes at least one of an active set of pilot signals and a candidate set of pilot signals and wherein the pilot strength measurement message further includes at least the short term filtered measurement data based on at least one of a number of pilot signals in the active set, and a number of pilot signals in the candidate set.

9. The wireless device of claim 6 wherein the pilot strength measurement message further includes at least the long term filtered measurement data if the strongest pilot signal represented by corresponding long term filtered measurement data is greater than a threshold.

10. The wireless device of claim 6 wherein the threshold includes the drop threshold +3 dB.

11. A wireless device for producing a pilot strength measurement message comprising:
a plurality of finger receivers each operative to receive at least one of an active pilot signal and a candidate pilot signal, and in response, operative to generate corresponding long term filtered measurement data;
a scan search receiver also operative to receive the at least one of the active pilot signal and the candidate pilot signal, and in response, operative to generate corresponding short term filtered measurement data; and
a pilot strength measurement message generator, operatively coupled to the plurality of finger receivers and to the scan search receiver, and operative to produce the pilot strength measurement message including at least the long term filtered measurement data if a strongest pilot signal represented by corresponding long term filtered measurement data generated by at least one of the plurality of finger receivers is greater than a threshold.

12. The wireless device of claim 11 wherein the pilot strength measurement message includes at least the long term filtered measurement data from the respective plurality of finger receivers if the strongest pilot signal represented by the long term filtered measurement data is less than the first threshold and greater than the second threshold, and if at least one of a number of candidate pilots is greater than three, and a number of active pilots is greater than one, otherwise, the pilot strength measurement message includes at least the short term filtered measurement data.

13. The wireless device of claim 11 wherein the threshold includes a drop threshold +3 dB.

14. A method for producing a pilot strength measurement message comprising:
receiving the long term filtered measurement data corresponding to at least one of a plurality of pilot signals, and short term filtered measurement data corresponding to at least one of the plurality of pilot signals; and
producing the pilot strength measurement message based on at least the long term filtered measurement data, in response to receiving the long term filtered measurement data corresponding to at least one of the plurality of pilot signals, and the short term filtered measurement data corresponding to at least one of the plurality of pilot signals.

15. The method of claim 14 further including:
producing the pilot strength measurement message based on at least the short term filtered measurement data if a strongest pilot signal represented by corresponding long term filtered measurement data is less than a threshold.

16. The method of claim 14 further including:
receiving an active set of pilot signals and a candidate set of pilot signals, and
producing the pilot strength measurement message including at least the short term filtered measurement data based on at least one of a number of pilot signals in the active set, and a number of pilot signals in the candidate set.

17. A method for producing a pilot strength measurement message comprising:
receiving a plurality of pilot signals;
producing long term filtered measurement data corresponding to at least one of the plurality of pilot signals;
producing short term filtered measurement data corresponding to at least one of the plurality of pilot signals;
producing the pilot strength measurement message including at least the long term filtered measurement data corresponding to at least one of the pilot signals, when a strongest pilot signal represented by corresponding long term filtered measurement data is greater than a threshold.

18. The method of claim 17 further including:
receiving an active set of pilot signals and a candidate set of pilot signals, and
producing the pilot strength measurement message including at least one of the long term filtered measurement data and the short term filtered measurement data, based on at least one of a number of pilot signals in the active set, and a number of pilot signals in the candidate set.

19. The method of claim 17 further including:
receiving an active set of pilot signals and a candidate set of pilot signals,
producing the pilot strength measurement message including at least the long term filtered measurement data when the strongest pilot signal represented by corresponding long term filtered measurement data is less than the first drop threshold and greater than the second threshold and at least one of when a number of candidate pilots is greater than one, and when a number of active pilots is greater than two.

20. A memory containing instructions executable by one or more processing devices that causes the one or more processing devices to:
receive long term filtered measurement data corresponding to at least one of a plurality of pilot signals, and short term filtered measurement data corresponding to at least one of the plurality of pilot signals
produce a pilot strength measurement message based on at least the long term filtered measurement data, in response to the received long term filtered measurement data corresponding to at least one of a plurality of pilot signals, and the received short term filtered measurement data corresponding to at least one of the plurality of pilot signals.

21. The memory of claim 20 containing executable instructions that cause the one or more processing devices to produce the pilot strength measurement message based on at least the short term filtered measurement data when a strongest pilot signal represented by corresponding long term filtered measurement data is less than a threshold.
